(19) United States
(12) Patent Application Publication
(10) Pub. No.: US 2005/0194724 A1
(43) Pub. Date: Sep. 8, 2005

(54) Method of forming a composite structure

(76) Inventors: Max Krogager, Linkoping (SE); Jan Vaara, Linkoping (SE)

Correspondence Address: SWIDLER BERLIN LLP, 3000 K STREET, NW, BOX IP, WASHINGTON, DC, 20007, US

(21) Appl. No.: 10/963,818

(22) Filed: Oct. 14, 2004

(30) Foreign Application Priority Data
Oct. 14, 2003 (EP) EP 03 07 8237

(51) Int. Cl. B29C 47/00

(52) U.S. Cl. 264/510

(57) ABSTRACT

The present invention relates to methods for forming composite structures and composite structures formed by these methods. The methods include arranging a stack of prepreg sheets on a mold. The composite material is substantially sealed within a vacuum bag. One or more vacuum ports extend through the vacuum bag. Vacuum is applied through the vacuum ports for drawing air from the stack of prepreg sheets. Air in the space between adjacent prepreg sheets in the stack is evacuated through at least one less-impregnated layer within a least one of the two adjacent prepreg sheets. The less impregnated layer communicates with the vaccum port. The process may be repeated until the stack comprises a predetermined number of prepreg sheets. The composite material is cured and the structure is released from the mold and the vacuum bag, thus providing a composite structure formed from evacuated, cured stack of prepreg sheets.

### CROSS REFERENCE TO RELATED APPLICATIONS

This application claims priority of European Patent Application EP 03078237.9, filed Oct. 14, 2003.

### FIELD OF THE INVENTION

The present invention relates to composites and, more specifically a method for forming composite structures.

### BACKGROUND OF THE INVENTION

Airplane manufacturers are under increasing pressure to produce lightweight, strong and durable aircraft at the lowest costs for manufacture and life cycle maintenance. An airplane must have sufficient structural strength to withstand stresses during flight while being as light as possible to maximize the performance of the airplane. For these reasons and others, aircraft manufacturers are increasingly using fiber-reinforced resin matrix composites to construct aircraft components.

Fiber-reinforced resin matrix composites provide good strength, fatigue resistance, stiffness, and strength-to-weight ratio by incorporating strong, stiff, carbon fibers into a softer, more ductile resin matrix. The resin matrix material transmits forces to the fibers and provides ductility and toughness while the fibers carry most of the applied force.

In prior methods of producing fiber-reinforced resin matrix components for aircraft, a number of sheets of so called “prepreg” are stacked on a mold. The prepreg consists of unidirectional fibers or multidimensional fibers in uncured resin. A vacuum bag is placed over and sealed around the entire structure. Vacuum is applied to the sealed structure so as to compact the prepreg sheets onto the surface of the mold.

In order to achieve aircraft quality in large composite parts, the structure must be placed in an autoclave which is pressurized so as to compact the prepreg sheets onto the mold. However, in large structures, pores are easily produced in portions of the compacted part as a result of air not being evacuated completely from the stack of prepreg sheets prior to the curing process. These pores decrease the strength of the cured composite part. In order to remedy this problem, prior methods include evacuating the air from a stack of prepreg sheets multiple times during lay-up of the sheets.

Additionally, prior methods require use of an autoclave in order to reach sufficient pressure during the curing process to minimize pore size. During the autoclave process of curing, air remaining between the prepreg sheets is distributed under pressure to pores of such size that their impact on the quality of the final composite structure was considered to be acceptable. However, in order to guarantee that there are no pores of unacceptably large size in the structure, the composite structure is examined using non-destructive testing, e.g. ultra-sound or other non-destructive methods, before approval to be used as part of an aircraft structure. If the testing reveals the presence of large pores, the composite structure must be rejected. Obviously, the production of composite parts that must be rejected is wasteful and uneconomical.

Thus there exists a need for an improved method for making large, fiber-reinforced resin matrix composite parts substantially free of pores.

### SUMMARY OF THE INVENTION

The present invention includes methods for forming composite structures and composite structures prepared using these methods. The methods include arranging a stack of prepreg sheets on a mold. The composite material is substantially sealed within a vacuum bag having at least one, and preferably more than one, vacuum port extending through the vacuum bag. Vacuum is applied through the vacuum ports for drawing air from the stack of prepreg sheets. Air in the space between each pair of adjacent prepreg sheets in the stack is evacuated through channels within at least one of the two adjacent prepreg sheets, wherein the channels communicate with the at least one vacuum port to allow air between the sheets to be drawn out efficiently and effectively. The composite material is cured, and the structure is released from the mold and the vacuum bag, thus providing a composite structure formed from evacuated, cured stack of prepreg sheets. Curing may occur in an oven, autoclave, or other curing device.

In a further embodiment, sheets, or stacks of sheets, are added sequentially to the stack on the mold, and the vacuum process is repeated until the stack comprises a desired number of prepreg sheets. The vacuum is released from the vacuum bag when sheets are added. If desired, the mold with stacks of prepreg sheets may be released from the vacuum bag when additional sheets are added.

In a preferred embodiment of the invention, the channels within the at least one prepreg sheet are filled with resin during the curing process. A less-impregnated layer, or dry layer, may be adjacent to a layer of pure resin prior to curing.

In another embodiment of the invention, each prepreg sheet in a stack is slightly rotated in relation to the preceeding sheet so that the direction of the fibers in two adjacent sheets do not coincide. This rotation may occur subsequent to the evacuation of air from between the sheets.

The prepreg sheets may made up of carbon fiber tape, fiberglass, silicon carbide, graphite or carbon, and may include a greater or lesser amount of resin. In a preferred embodiment, the prepreg sheets are made of carbon fiber tape impregnated with epoxy resin.

The methods according to the present invention provide a composite structure formed with a substantially reduced need for intermediate vacuuming when applying the sheets in a stack. Thus, the reduction in time and cost for producing each composite structure is considerable.

### BRIEF DESCRIPTION OF THE DRAWINGS

These aspects and many additional advantages of the present invention will become more readily appreciated and better understood by reference to the following detailed description, when taken in conjunction with the accompanying drawings.

FIG. 1 is a cross-sectional view of a stack of prepreg sheets arranged in accordance with an embodiment of the invention.

FIG. 2 is a cross-sectional view of a stack of prepreg sheets arranged in accordance with an embodiment of the invention.

### DETAILED DESCRIPTION OF THE INVENTION

The present invention will be described with reference to formation of a fiber-reinforced composite structure for an aircraft component. However, the present invention is particularly beneficial for forming composite structures irrespective of the size or configuration of the structures or their ultimate use.

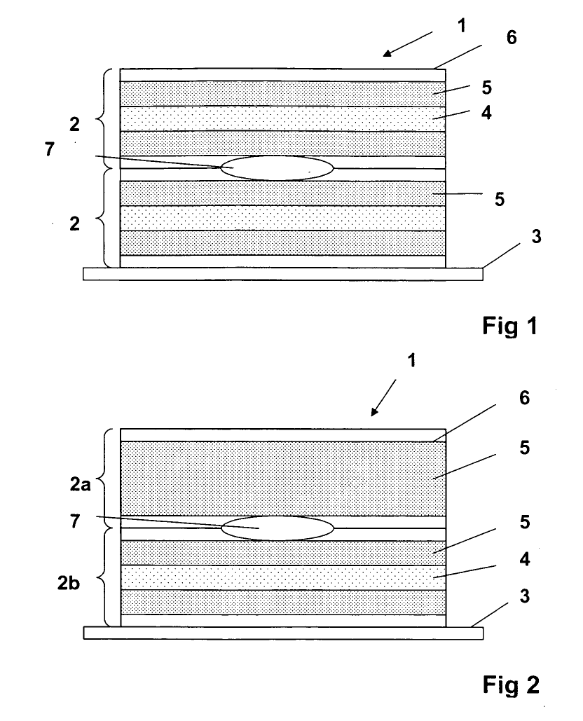

FIGS. 1 and 2 each disclose a stack 1 of prepreg sheets 2 arranged on a lay-up mold 3 that has a forming surface. The upper face of the lay-up mold usually has a contour that substantially matches the outer surface of the part being formed.

Conventional methods of arranging prepreg sheets on a lay-up mold may be used in conjunction with the present invention. A stack of prepreg sheets 2 is placed on the mold 3. The prepreg sheets 2 preferably include carbon fiber tape impregnated with epoxy resin. A prepreg sheet 2 consists of layers of resin and fibers embedded in resin. In the embodiment disclosed in FIG. 1, each prepreg sheet includes a less-impregnated layer 4, a layer of so called “dry fibers,” in a middle section of the prepreg sheet 2. The less-impregnated layer is surrounded by other layers 5 of fully impregnated resin, preferably with unidirectional fiber arrangement.

Channels or airpaths are formed within the layers of the prepreg sheets. Such channels may be formed in a variety of ways. In a preferred embodiment, the layer 4 of less-impregnated fibers in the prepreg sheet 2 functions to provide a multitude of such channels or airpaths for evacuating air during the debulking and curing process. It is preferred that the prepreg sheets are embedded with unidirectional continuous fibers in the resin of each prepreg sheet for improved airflow. While multi-directional fiber arrangements may be used in the methods of the present invention, prepreg sheets laid up with a multitude of fiber angles are less efficient in the passage of air through all of the layers because the different fiber angles may block air movements in adjacent layers. If the prepreg sheet only has one fiber angle, the air can more easily spread the fibers so that the air may find a way out through the sheet. In order to increase the strength in the final composite structure, the sheets may be slightly rotated in relation to one another after de-gassing, but prior to curing, to increase the strength of the composite structure.

Although a carbon fiber/epoxy composite is preferred, the invention can be used with other composite materials. The fibers can be, for example, fiberglass, silicon carbide, graphite or carbon. The present invention has particular relevance to making pore-free composites because the method allows air in between the sheets to escape to a higher degree than was possible with previous methods.

FIG. 2 discloses a second embodiment of the invention; wherein a stack of prepreg sheets is arranged so that every second prepreg sheet 2b include a less-impregnated layer 4, or dry layer. The less-impregnated layer 4, or dry layer, may be surrounded by fully impregnated layers 5 or may be adjacent to a single fully impregnated layer 5. Pure resin 6 is applied in a very thin layer on each side of the prepreg sheet in order to improve the adhesion between two separate prepreg sheets 2a,2b. In a preferred embodiment, the prepreg sheet 2a adjacent to the sheet 2b, which includes a dry layer 4, may be made up of a fully impregnated layer 5, surrounded on each side by one or more very thin layers 6 of pure resin.

The layers of prepreg sheets 2 are placed onto the upper face of the lay-up mold 3 using hand lay-up procedures, automated tape laying procedures, or other appropriate procedures. In a preferred embodiment of the invention, a metal plate is arranged on one side of a stack of prepreg sheets. The lay-up mold and the metal plate represent two good surfaces which are unaffected by external air paths. The prepreg sheets 2 are arranged so that at least every second sheet includes a less-impregnated layer 4 or dry layer. Each less-impregnated layer 4 constitutes an airpath or channel that extends from the perimeter of the sheet to the inner part of the sheet or all the way through the sheet. A stack of prepreg sheets thus includes a number of airpaths or channels extending into the stack 1 through the arrangement including layers of less-impregnated fibers or dry layers.

The stack 1 of prepreg sheets 2 is placed into a vacuum bag that includes at least one vacuum port. The at least one vacuum port is connected to at least one vacuum hose and air is evacuated from the enclosed stack of prepreg sheets. Upon completion of the evacuation process, the evacuated vacuum bag is in direct contact with the surface of the lay-up over the entire surface.

Via the less-impregnated layers 4, air paths are formed within a predetermined number of prepreg sheets 2 in the stack 1. Due to these air paths, there is no need to apply external pressure outside the vacuum bag. Furthermore, it is possible to apply to the mold a much larger number of prepreg sheets 2 in a single stack 1 without an intermediate evacuation process. The air trapped between the sheets is forced into the less-impregnated layer(s) 4 and may be evacuated from the stack by means of vacuum pressure alone during a single evacuation process. This method avoids the presence of trapped air pockets or wrinkles between the sheets as air 7 trapped between two adjacent prepreg sheets 2 is evacuated through the channels formed by the less-impregnated layer 4 during the evacuation process.

Subsequently, the whole assembly is placed in an oven. No high-pressure autoclave is necessary, although an autoclave or other type of oven under atmospheric or super-atmospheric pressure may be used as desired. Curing occurs by heating the prepreg sheets 2 to a predetermined temperature in the oven. It is therefore possible to obtain a high, aircraft standard laminate quality with only vacuum and heat.

In a preferred embodiment, the air paths or less-impregnated layers 4 are filled with resin during curing.

Since the inventive method is faster than previous methods, less time elapses between the stacking of the first and last prepreg layers of the lay-up. Cured composite articles produced according to the present methods display more complete and uniform bonding between the prepreg layers of the lay-up than articles produced according to previous methods. Moreover, since the need for displacement of air pockets is eliminated there is much less disruption of the alignment of fibers in the prepreg layers of the lay-up.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. For example, while less-impregnated layers are described as forming the air channels of the present invention, other methods of forming such channels may be used. Such modifications are also intended to fall within the scope of the appended claims. Therefore, it is intended that the appended claims cover all such modifications and embodiments that fall within the true spirit and scope of the present invention. The invention extends past the specific embodiments described to include those equivalent methods as will be apparent to those skilled in the art from the claims.

1. A method of forming a composite structure, comprising:
a) arranging a stack of prepreg sheets on a mold, said prepreg sheets comprising a plurality of impregnated layers, wherein at least one of said prepreg sheets further comprises at least one air channel;
b) enclosing said stack within a vacuum bag having at least one vacuum port, wherein said at least one vacuum port communicates with said at least one air channel;
c) evacuating the vacuum bag through the at least one vacuum port to create a vacuum, whereby upon completion of the evacuation said stack of prepreg sheets is essentially air-free; and
d) curing the stack of prepreg sheets to form said composite structure.

2. The method of claim 1, further comprising releasing the stack from the vacuum bag prior to step d).

3. The method of claim 1, further comprising releasing the composite structure from the mold and the vacuum bag subsequent to step d).

4. The method of claim 1, further comprising adding additional prepreg sheets prior to step d) and repeating steps a) through c).

5. The method of claim 1, wherein said at least one air channel comprises at least one less-impregnated layer.

6. The method of claim 1, wherein said at least one air channel comprises at least one dry layer.

7. The method of claim 5, wherein said at least one less-impregnated layer is adjacent to at least one fully impregnated layer.

8. The method of claim 1, wherein said at least one air channel is present within at least every second sheet.

9. The method of claim 6, wherein said at least one less-impregnated layer is adjacent to at least one layer of pure resin.

10. The method of claim 1, wherein said prepreg sheets comprise resin and fibers.

11. The method of claim 10, wherein said sheets have unidirectional fiber arrangement.

12. The method of claim 10, wherein said prepreg sheets comprise carbon fiber tape, fiberglass, silicon carbide, graphite or carbon.

13. The method of claim 10, wherein said prepreg sheets comprise carbon fiber tape impregnated with epoxy resin.

14. The method of claim 1, wherein said air channel is filled with resin during curing.

15. The method of claim 5, wherein said less impregnated layer is filled with resin during curing.

16. The method of claim 1, wherein each prepreg sheet in a stack is slightly rotated in relation to the preceeding sheet.

17. The method of claim 16, wherein said rotation occurs subsequent to step c).

18. The method of claim 17, wherein said rotation occurs so that the orientations of fibers in two adjacent sheets do not coincide.

19. The method of claim 1, wherein said curing occurs in an oven.

20. A composite structure, comprising an evacuated, cured stack of prepreg sheets, wherein said structure is prepared by:
a) arranging a stack of prepreg sheets on a mold, said prepreg sheets comprising a plurality of impregnated layers, wherein at least one of said prepreg sheets further comprises at least one air channel;
b) enclosing said stack within a vacuum bag having at least one vacuum port, wherein said at least one vacuum port communicates with said at least one air channel;
c) evacuating the vacuum bag through the at least one vacuum port to create a vacuum, whereby upon completion of the evacuation said stack of prepreg sheets is essentially air-free; and
d) curing the stack of prepreg sheets;
to provide said composite structure.
